(19) United States
(12) Patent Application Publication
(10) Pub. No.: US 2011/0171507 A1
(43) Pub. Date: Jul. 14, 2011

(54) SECONDARY BATTERY

(75) Inventor: Daekyu Kim, Yongin-si (KR)

(73) Assignee: Samsung SDI Co., Ltd., Yongin-si (KR)

(21) Appl. No.: 12/945,774

(22) Filed: Nov. 12, 2010

(30) Foreign Application Priority Data
Jan. 11, 2010 (KR) 10-2010-0002283

(51) Int. Cl. H01M 2/02

(52) U.S. Cl. 429/94; 429/185

(57) ABSTRACT

A secondary battery includes an electrode assembly, a can, a cap assembly, and a gasket. The electrode assembly includes a wound stack of two mutually different electrodes and a separator interposed between the two electrodes. The can houses the electrode assembly. The cap assembly is assembled at an upper portion of the can. The gasket is interposed and pressed between the cap assembly and the upper portion of the can, to maintain insulation and a seal between the cap assembly and the can. An adhesive layer of an applied low-viscosity adhesive liquid is provided at an inner side of the gasket to increase sealing force between the cap assembly and the can.

### CROSS-REFERENCE TO RELATED APPLICATION

This application claims the benefit of Korean Patent Application No. 10-2010-0002283, filed Jan. 11, 2010 in the Korean Intellectual Property Office, the disclosure of which is incorporated herein by reference.

### BACKGROUND

1. Field

Embodiments relate to a secondary battery.

2. Description of the Related Art

In general, secondary batteries may be categorized into cylinder type batteries, prismatic type batteries or pouch type batteries, depending on the shapes of their cases in which electrode assemblies are housed. In a cylinder type secondary battery, after an electrode assembly is inserted into a cylindrical can, a cap assembly is assembled on the top opening of the cylindrical can, and the cap assembly is electrically connected to the electrode assembly to transfer electrical current externally.

A beading portion is defined in the upper sidewall of the can to prevent the electrode assembly from moving within the can. A gasket is installed at the inner sidewall at the open top of the can to hold and couple components and seal the inside of the can, and the cap assembly is installed to the inside of the gasket to complete the seal at the top opening of the can. The secondary battery is also typically provided with a cap up, etc. as a cover to be coupled at the inside of the gasket, and crimping is performed to the top wall at the opening of the can, to which inward and downward pressure is applied to seal the can.

The gasket is usually coated with tar or a similar material on the inside to maintain its seal and provide adherence. However, uniform coating of tar is difficult to achieve, so that the integrity of the seal may be compromised from the crimping process.

### SUMMARY

Aspects of the present invention provide a secondary battery that can not only ensure sufficient sealing capability by retaining the seal integrity of a gasket that is sealed against the outer periphery of a cap assembly, but also capable of preventing deformation of a Current Interrupt Device (CID).

According to at least one of embodiments, a secondary battery including: an electrode assembly including a wound stack of two mutually different electrodes and a separator interposed between the two electrodes; a can housing the electrode assembly; a cap assembly assembled at an upper portion of the can housing the electrode assembly; and a gasket interposed and pressed between the cap assembly and the upper portion of the can, for maintaining an insulation and a seal between the cap assembly and the can, wherein an adhesive layer of an applied low-viscosity adhesive liquid is provided at an inner side of the gasket to increase sealing force between the cap assembly and the can.

The gasket may include: a bent portion interposed to be pressed and bent between the cap assembly and the upper portion of the can; an extending portion extending toward a center at a lower portion of the bent portion; a seat defining an inner peripheral upper shelf of the extending portion, and having the cap assembly seated thereon; and a recess defined in an inward periphery of the seat, wherein the low-viscosity adhesive liquid is filled in the recess.

The low-viscosity adhesive liquid may include an acrylic-based adhesive and a solvent. The solvent may include at least one selected from carbonate-based solvents used in electrolyte. The solvent may be dimethyl carbonate. The low-viscosity adhesive liquid may have a viscosity from about 500 cps to about 2,000 cps. The low-viscosity adhesive liquid may have a viscosity from about 1,000 cps to about 1,800 cps. The low-viscosity adhesive liquid may further include a hardener.

A distance B from an inner surface of the bent portion to an outermost inflection point of the recess may be from about 0.42 mm to about 0.98 mm. The distance B from the inner surface of the bent portion to the outermost inflection point of the recess may be from about 0.55 mm to about 0.98 mm.

### BRIEF DESCRIPTION OF THE DRAWINGS

The above and other aspects and advantages of the invention will become more apparent to those of ordinary skill in the art by describing in detail exemplary embodiments with reference to the attached drawings, in which:

FIG. 1 illustrates a cross-sectional view of a secondary battery according to an embodiment;

FIG. 2 illustrates an enlarged cross-sectional view of the cap assembly portion in FIG. 1;

FIG. 3 illustrates an enlarged view of region III in FIG. 2;

FIG. 4 illustrates a perspective view of a gasket provided with a supplemental sealing member according to an embodiment;

FIG. 5 illustrates a sectional view of the gasket in FIG. 4; and

FIGS. 6A and 6B are schematic views illustrating a process of crimping the upper end of a cylindrical can according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

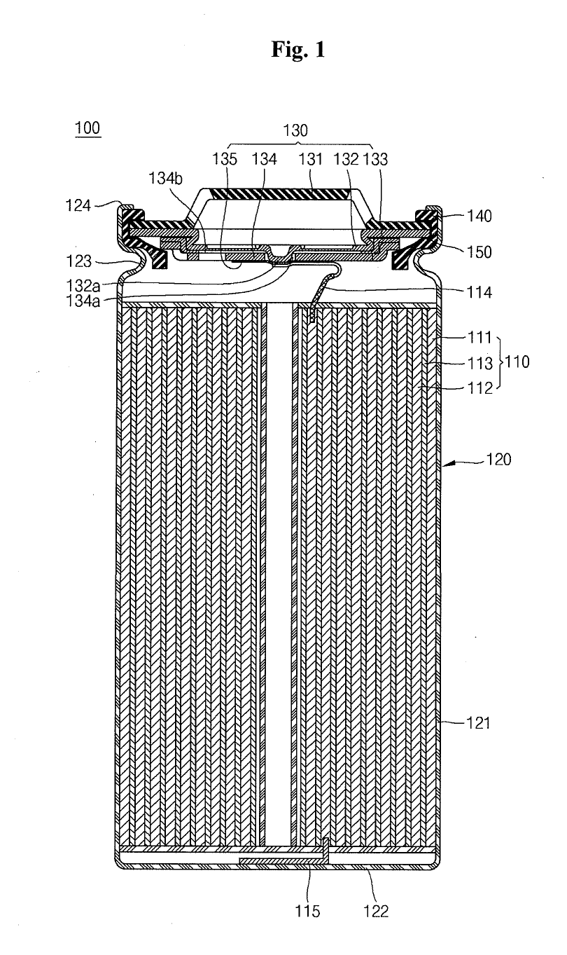

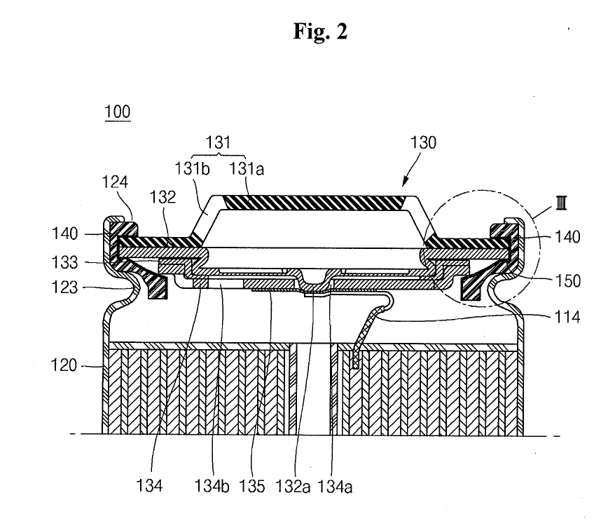

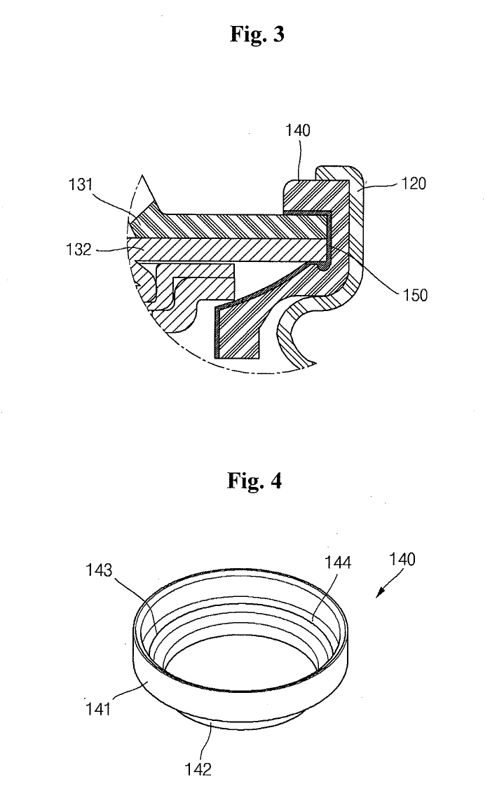

FIG. 1 illustrates a cross-sectional view of a secondary battery according to an embodiment, FIG. 2 illustrates an enlarged cross-sectional view of the cap assembly portion in FIG. 1, FIG. 3 illustrates an enlarged view of region III in FIG. 2.

Referring to FIGS. 1 to 3, a secondary battery 100 according to an embodiment includes an electrode assembly 110, a cylindrical can 120 into which the electrode assembly 110 is inserted, a cap assembly 130 that is coupled to the open upper end of the cylindrical can 120 while having the electrode assembly 110 within the cylindrical can 120 inserted therein, and a gasket 140 installed at the inner periphery of the open upper end of the cylindrical can 120, on which the cap assembly 130 is mounted.

The electrode assembly 110 is configured in a jelly roll shape, wound with a positive electrode plate 111 having positive electrode active materials coated on the surface of a positive electrode collector, a negative electrode plate 112 having negative electrode active materials coated on the surface of a negative electrode collector, and a separator 113 disposed between the positive electrode plate 111 and the negative electrode plate 112 to electrically insulate the positive electrode plate 111 from the negative electrode plate 112. A positive electrode tab 114 is connected to the cap assembly 130 at the upper portion of the electrode assembly 110, and a negative electrode tab 115 is connected to the floor of the can 120 at the lower portion of the electrode assembly 110.

The positive electrode collector of the positive electrode plate 111 is formed of a conductive metal material so that it can collect electrons from a positive electrode active material layer and move the electrons to an external circuit. The positive electrode active material layer is made by mixing positive electrode active materials with conductive material and binder, and is coated on the positive electrode collector at a predetermined thickness. A positive electrode non-coating portion is formed at either end of the positive electrode plate 111 of the positive electrode collector that does not have the positive electrode active materials formed thereon, and the positive electrode tab 114 is welded to an end of the non-coating portion.

The negative electrode collector of the negative electrode plate 112 is formed of a conductive metal material so that it can collect electrons from a negative electrode active material layer and move the electrons to an external circuit. The negative electrode active material layer is made by mixing negative electrode active materials with conductive material and binder, and is coated on the negative electrode collector at a predetermined thickness. A negative electrode non-coating portion is formed at either end of the negative electrode plate 112 of the negative electrode collector that does not have the negative electrode active materials formed thereon, and the negative electrode tab 115 is welded to an end of the non-coating portion.

The separator 113 may be interposed between the positive electrode plate 111 and the negative electrode plate 112, and may extend to enclose the outer periphery of the electrode assembly 110. The separator 113 is formed as a porous layer of high polymer material that prevents shorting of the positive electrode plate 111 and negative electrode plate 112 and admits lithium ions therethrough.

The cylindrical can 120 is formed of a cylindrical side surface plate 121 having a uniform diameter to define a space in which to hold the electrode assembly 110, and a bottom surface plate 122 for sealing the bottom of the side surface plate 121. The cylindrical can 120 is typically formed of a conductive metal that is lightweight such as aluminum or aluminum alloy, and is formed using dip drawing, etc. The top end of the cylindrical can 120 is open to insert the electrode assembly 100 and be sealed thereafter. Also, a beading portion 123 is formed at the upper portion of the cylindrical can 120 to prevent movement of the electrode assembly 100. Further, a crimping portion 124 is formed for fixing the cap assembly 130 to the uppermost end of the cylindrical cap 120.

The can assembly 130 includes a cap-up 131 electrically connected to the electrode assembly 110 for transferring a current occurring at the electrode assembly 110 to the outside. The cap assembly 130 also includes a safety vent 132 with its top surface pressed against the bottom surface of the cap-up 131 to disconnect current and release internal gas pressure when abnormal gas pressure build-up occurs in the cylindrical can 120 and a cap-down 134 installed below the safety vent 132 to seal the inside of the cylindrical can 120 An insulator 133 is also installed between the safety vent 132 and the cap-down 134, and a sub plate 135 fixed to the undersurface of the cap down 134 and the positive electrode tab 114 attached to the cap down 134.

The cap-up 131 is formed as a round plate with a terminal portion 131a formed projecting in the center to electrically connect with the outside. A plurality of gas exhaust holes 131b is formed at the outer perimeter of the terminal portion 131a to exhaust gas generated inside the cylindrical can.

The safety vent 132 is formed as a round plate corresponding to the cap-up 131, and has a projection 132a formed projecting downward at the center thereof.

The insulator 133 is interposed between the safety vent 132 and the cap-down 134, and is formed of a material for providing insulation therebetween.

The cap-down 134 is formed as a round plate, and defines a central through-hole 134a in the center thereof through which the projection 132a of the safety vent 132 passes. A gas exhaust hole 134b, for exhausting gas that elevates the projection 132a of the safety vent 132 when excessive internal pressure build-up occurs, is defined at a side of the cap-down 134.

The sub plate 135 is welded to the projection 132a of the safety vent 132 that passes through the central through-hole 134a of the cap-down, to electrically connect the positive electrode tab 114 with the safety vent 132.

Also, while not illustrated in the drawings, a PTC device being a secondary protective device may be further installed between the cap-up 131 and the safety vent 132.

The cap-up 131 and the safety vent 132 are seated on an inner peripheral seating portion of the gasket 140 installed at the open top end of the cylindrical can 120, and the gasket 140 is sealed and assembled against the outer periphery of the cap-up 131.

The gasket 140 is compressed and fixed while interposed between the cap assembly 130 and the top of the can 120. Thus, the gasket 140 provides a seal and insulation between the can 120 and the cap assembly 130, while also absorbing shocks from when the electrode assembly 110 moves due to the battery being dropped or jostled, and expediting the commencement of CID (Current Interrupt Device) operation in the event of an overcharge.

The adhesive layer 150 is formed on the inner surface of the gasket 140 to increase sealing force between the cap assembly 130 and the can 120, and is formed through applying a low-viscosity adhesive liquid. The adhesive layer 150 supplements the sealing force between the cap assembly 130 and the can 120. When the seal is thus improved, leakage of electrolyte is less likely to occur.

The low-viscosity adhesive liquid may be made to include an acrylic-based adhesive and a solvent. The acrylic-based adhesive used may be selected from PMMA (Poly Methyl Methacrylate), PEMA (Poly Ethyl Methacrylate), and PBMA (Poly Butyl Methacrylate).

The solvent used may be a carbonate-based solvent typically used in electrolyte, and the carbonate-based solvent may be selected from DMC (Dimethyl Carbonate), DEC (Diethyl Carbonate), DPC (Dipropyl Carbonate), MPC (Methyl Propyl Carbonate), EPC (Ethyl Propyl Carbonate), MEC (Methyl Ethyl Carbonate), EC (Ethylene Carbonate), PC (Propylene Carbonate), BC (Butylene Carbonate), and the like. DMC may be included and used.

The low-viscosity adhesive liquid may have a viscosity of about 500 to about 2,000 cps, or more particularly, about 1,000 to about 1,800 cps. If the viscosity of the low-viscosity adhesive liquid is 500 cps or below, an insufficient seal will result leading to scattered sealing, and if the viscosity of the low-viscosity adhesive liquid is greater than 2,000 cps, component placement is rendered difficult.

The low-viscosity adhesive liquid may further include a hardener.

The hardener used is not particularly limited in as long as it is one that can quicken hardening of the acrylic-based adhesive. The hardener used may be isocyanate-based hardener, which is a common hardener that is well-known in the acrylic-based adhesive field.

The gasket 140 may be formed of a bent portion 141, an extending portion, a seat 143, and a recess 144 defined in the seat 143.

The bent portion 141 is a portion that is interposed between the cap assembly 130 and the upper part of the can 120, and pressed and bent during crimping. With the gasket 140 inserted in the opening at the top of the cylindrical can 120 at the inner periphery thereof, the cap assembly 130 is seated, and the top portion of the cylindrical can 120 is crimped. In this process of crimping the top end of the cylindrical can 120, the bent portion 141 of the gasket 140 is maintained to provide a certain sealing force against the cap-up 131 and the outer periphery of the safety vent 132.

The extending portion 142 is formed to extend downward and concentrically inward from the bent portion 141. The extending portion 142 acts as a primary shock barrier for inhibiting shock from a jelly roll or center pin being imparted on the safety vent 132 when the battery is dropped.

The bent portion 141 and the extending portion 142 may be integrally formed, and the bent portion 141 and the extending portion 142 may be formed of a material that can absorb shock imparted by the electrode assembly 110 or a center pin when the battery is dropped or shaken. In addition, the bent portion 141 and the extending portion 142 may be formed of a material that can provide insulation between the electrode assembly 110 and the cap assembly 130. The bent portion 141 and the extending portion 142 may be formed of a material that does not react to electrolyte. The material is not particularly limited and may be any typical material used in the field of manufacturing the gasket 140, and may be polypropylene, for example.

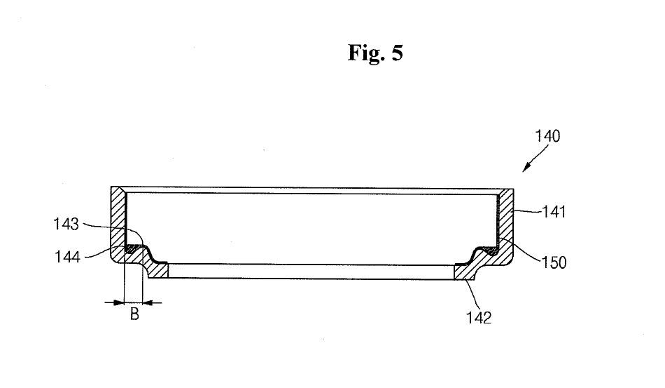

The distance B (in FIG. 5) from the inner surface of the bent portion 141 to the outermost inflection point of the recess may be about 0.42 mm to about 0.98 mm. If the distance B is less than 0.55 mm, maintaining sealing pressure is more difficult, and a dispersed seal would result. If the distance B is greater than 0.98 mm, the gasket may interfere with CID components and cause malfunctioning thereof.

The seat 143 defines the inner peripheral upper shelf of the extending portion 142, on which the cap assembly 130 is seated. In particular, the undersurface edge of the safety vent 132 of the cap assembly 130 is seated.

The seat 143 may define the recess 144 around the inner periphery thereof; and the low-viscosity adhesive liquid may be filled in the recess 144. In this case, when the low-viscosity adhesive liquid hardens, the hardened portion presses against the undersurface side edge of the safety vent 132, to help in ensuring sufficient sealing force.

The manufacturing process of a secondary battery according to embodiments will be described with reference to FIGS. 1 to 3.

The assembly sequence of a secondary battery involves inserting an electrode assembly 110 into a cylindrical can 120, injecting electrolyte, then sealing the open top end of the cylindrical can 120 with a cap assembly 130.

The cap assembly 130 is assembled by assembling a cap-up 131 and safety vent 132, followed by positioning an insulator 133 atop a cap-down 134 and assembling the same. That is, the safety vent 132 is assembled by passing the projection 132a through the central through-hole 134a of the cap-down 134 and assembling the same, and welding the sub plate 135 to the projection 132a of the safety vent 132.

A beading portion 123 is formed in the top portion of the cylindrical can 120, to prevent movement of the electrode assembly 110, after the electrode assembly 110 is inserted into the cylindrical can 120 and electrolyte has been injected. Also, with a gasket provided with a sealing adhesive layer 150 inserted at the inner periphery of the open top of the cylindrical can 120, the assembled cap assembly 130 is seated, and the top end of the cylindrical can 120 is crimped.

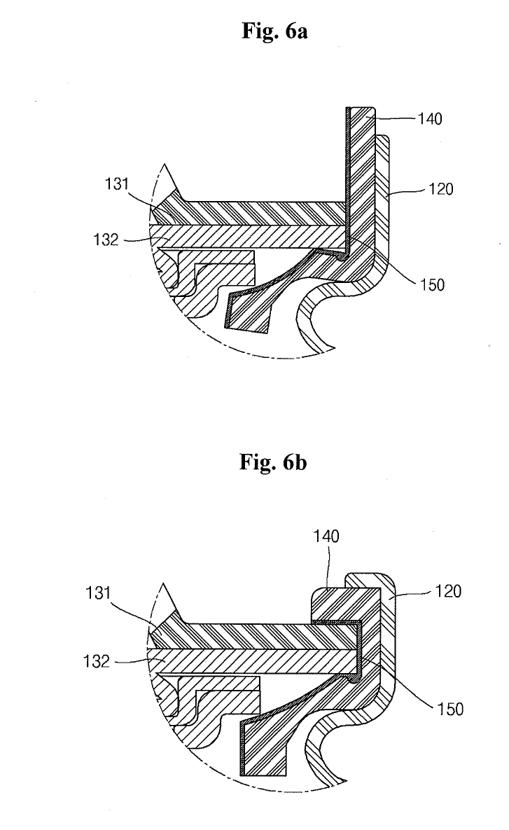

FIGS. 6A and 6B are schematic views illustrating a process of crimping the upper end of a cylindrical can according to an embodiment.

As illustrated in FIG. 6A, for performing crimping, first, with the gasket 140 provided with the adhesive layer 150 inserted at the inner periphery in the open top of the cylindrical can 120, the cap assembly 130 is seated.

Then, when the top end of the cylindrical can 120 is crimped, the bent portion 141 of the gasket 140 is maintained pressed against the outer peripheries of the cap-up 131 and safety vent 132 with a certain amount of sealing force, as illustrated in FIG. 6B. Here, the adhesive layer 150 encloses and seals the side edge of the cap assembly 130, in order to provide more sealing force than when only the gasket 140 is used. Also, dispersion of the sealing force can be prevented.

Below, a detailed description of an embodiment will be provided through the test example below.

### Test Example 1

To verify the change in sealing force according to the change in viscosity, DMC was mixed with PMMA, and a low-viscosity adhesive liquid was made for each level of viscosity in Table 1 below. Then, the adhesive liquids were respectively applied to the inside of a gasket as illustrated in FIGS. 1 to 3 to form adhesive layers. These were used in the process of manufacturing secondary batteries, their sealing forces were measured through the methods below, and the results are shown in Table 2 below.

To measure sealing pressure, a hole was bored in the outside of an assembled secondary battery, and nitrogen was introduced therein. Simultaneously, soapy water was applied to the sealed portion of the secondary battery, and pressure was measured at points where bubbles arose. A total of 3 tests were conducted, and the results are shown in Table 1.

TABLE 1

| | Comparison | Embodi- | Comparison | Embodi- |
|---|---|---|---|---|
| | Example 1 | ment 1 | Example 2 | ment 2 |
| Viscosity(cps) | 398 | 585 | 2835 | 853 |
| Mixing Ratio | 7:3 | 5:5 | 4:6 | 5.5:4.5 |
| (Adhesive:DMC) | | | | |

TABLE 2

| | Comparison Example 1 | | Embodiment 1 | | Comparison Example 2 | | Embodiment 2 | |
|---|---|---|---|---|---|---|---|---|
| | Operating | Sealing | Operating | Sealing | Operating | Sealing | Operating | Sealing |
| | Pressure | Pressure | Pressure | Pressure | Pressure | Pressure | Pressure | Pressure |
| 1st | 12.80 | 29.50 | 13.20 | 30.30 | 13.20 | 30.50 | 12.80 | 29.80 |
| 2nd | 12.90 | 29.50 | 12.80 | 31.00 | 13.00 | 30.00 | 12.80 | 30.50 |
| 3rd | 12.90 | 30.50 | 14.00 | 30.70 | 30.70 | 30.40 | 12.30 | 31.60 |

As illustrated in Tables 1 and 2 above, good sealing pressure can be obtained according to embodiments when gaskets are used that are provided with low viscosity adhesive layers of certain viscosity parameters.

A secondary battery according to embodiments can ensure sufficient sealing capability with an adhesive layer for sealing a gasket against the outer periphery of a cap-up and safety vent, without having to apply tar, and can prevent deformation of a CID.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery comprising:
an electrode assembly including a wound stack of two mutually different electrodes and a separator interposed between the two electrodes;
a can housing the electrode assembly;
a cap assembly assembled at an upper portion of the can housing the electrode assembly; and
a gasket interposed and pressed between the cap assembly and the upper portion of the can, for maintaining an insulation and a seal between the cap assembly and the can,
wherein an adhesive layer of an applied low-viscosity adhesive liquid is provided at an inner side of the gasket to increase sealing force between the cap assembly and the can.

2. The secondary battery as claimed in claim 1, wherein the gasket comprises:
a bent portion interposed to be pressed and bent between the cap assembly and the upper portion of the can;
an extending portion extending toward a center at a lower portion of the bent portion;
a seat defining an inner peripheral upper shelf of the extending portion, and having the cap assembly seated thereon; and
a recess defined in an inward periphery of the seat,
wherein the low-viscosity adhesive liquid is filled in the recess.

3. The secondary battery as claimed in claim 1, wherein the low-viscosity adhesive liquid includes an acrylic-based adhesive and a solvent.

4. The secondary battery as claimed in claim 3, wherein the solvent includes at least one selected from carbonate-based solvents used in electrolyte.

5. The secondary battery as claimed in claim 3, wherein the solvent is dimethyl carbonate.

6. The secondary battery as claimed in claim 1, wherein the low-viscosity adhesive liquid has a viscosity from about 500 cps to about 2,000 cps.

7. The secondary battery as claimed in claim 4, wherein the low-viscosity adhesive liquid has a viscosity from about 1,000 cps to about 1,800 cps.

8. The secondary battery as claimed in claim 3, wherein the low-viscosity adhesive liquid further includes a hardener.

9. The secondary battery as claimed in claim 2, wherein a distance B from an inner surface of the bent portion to an outermost inflection point of the recess is from about 0.42 mm to about 0.98 mm.

10. The secondary battery as claimed in claim 9, wherein the distance B from the inner surface of the bent portion to the outermost inflection point of the recess is from about 0.55 mm to about 0.98 mm.

11. A secondary battery comprising:
an electrode assembly;
a can that receives the electrode assembly;
a cap assembly positioned on the can;
a gasket that is interposed between the cap assembly and the can;
a low-viscosity adhesive layer that is interposed between the cap assembly and the gasket so as to adhere the cap assembly to the gasket.

12. The secondary battery of claim 11, wherein the gasket comprises:
a bent portion that is interposed, pressed and bent between the cap assembly and the upper portion of the can;
an extending portion that extends towards a center of the cap assembly;
a seat that is formed on the extending portion that receives the cap assembly;
a recess formed in the seat that receives the adhesive.

13. The secondary battery of claim 11, wherein the low-viscosity adhesive layer is formed of a low-viscosity adhesive liquid that includes an acrylic-based adhesive and a solvent.

14. The secondary battery of claim 13, wherein the solvent includes at least one selected from carbonate-based solvents used in electrolyte.

15. The secondary battery of claim 14, wherein the solvent is dimethyl carbonate.

16. The secondary battery of claim 13, wherein the low viscosity adhesive liquid has a viscosity of about 500 cps to about 2000 cps.
